(19) United States
(12) Patent Application Publication
(10) Pub. No.: US 2019/0011030 A1
(43) Pub. Date: Jan. 10, 2019

(54) FLUID-TYPE ROTARY BLADED WHEEL

(71) Applicant: EXEDY Corporation, Neyagawa-shi, Osaka (JP)

(72) Inventors: Yuki KAWAHARA, Neyagawa-shi, Osaka (JP); Takuma SHIMADA, Neyagawa-shi, Osaka (JP)

(73) Assignee: EXEDY Corporation, Neyagawa-shi ,Osaka (JP)

(21) Appl. No.: 16/065,347

(22) PCT Filed: Dec. 28, 2016
(86) PCT No.: PCT/JP2016/089146

§ 371 Date: Jun. 22, 2018

(30) Foreign Application Priority Data
Mar. 4, 2016 (JP) 2016-042023

(51) Int. Cl. F16H 41/28; F16H 41/26

(52) U.S. Cl. CPC F16H 41/28; F16H 41/26

(57) ABSTRACT

A fluid-type rotary bladed wheel to be used for a torque converter includes a shell and a plurality of blades each fixed to an inner surface of the shell. Each of the plurality of blades extends in a radial direction and an axial direction. The plurality of respective blades are disposed at intervals in a circumferential direction. The fluid-type rotary bladed wheel also includes a plurality of reinforcing portions each extending in the radial direction along a root between the shell and each of the plurality of blades. Each of the plurality of reinforcing portions joins the shell and each of the plurality of blades. The shell, the plurality of blades and the plurality of reinforcing portions are integrated.

### CROSS-REFERENCE TO RELATED APPLICATIONS

This application is the U.S. National Phase of PCT International Application No. PCT/JP2016/089146, filed on Dec. 28, 2016. That application claims priority to Japanese Patent Application No. 2016-042023, filed Mar. 4, 2016. The contents of both applications are herein incorporated by reference in their entirety.

### TECHNICAL FIELD

The present disclosure relates to a fluid-type rotary bladed wheel.

### BACKGROUND ART

In general, torque converters include an impeller, a turbine and a stator. Fluid-type rotary bladed wheels such as the impeller and the turbine include a shell and a plurality of blades (see Japan Laid-open Patent Application Publication No. 2011-002005). The plurality of respective blades are annularly disposed while being fixed to the inner peripheral surface of the shell.

### BRIEF SUMMARY

Each of the plurality of blades includes a protruding portion, and the shell is provided with a plurality of through holes, each of which corresponds to the protruding portion. The protruding portion is bent while penetrating each of the through holes provided in the shell, and is brazed thereto. Accordingly, each of the plurality of blades is fixed to the shell. It is preferable to enhance joint strength between each of the plurality of blades and the shell.

It is an object of the present disclosure to enhance joint strength between each of blades and a shell.

### Solution to Problems

A fluid-type rotary bladed wheel according to a first aspect of the present disclosure is used for a torque converter. The fluid-type rotary bladed wheel includes a shell, a plurality of blades and a plurality of reinforcing portions. Each of the plurality of blades is fixed to an inner surface of the shell. Each of the plurality of blades extends in a radial direction and an axial direction. The plurality of respective blades are disposed at intervals in a circumferential direction. Each of the plurality of reinforcing portions extends in the radial direction along a root between the shell and each of the plurality of blades. Each of the plurality of reinforcing portions joins the shell and each of the plurality of blades. The shell, the plurality of respective blades and the plurality of respective reinforcing portions are integrated.

According to this configuration, each of the plurality of reinforcing portions extends along the root between the shell and each of the plurality of blades. Hence, joint strength between the shell and each of the plurality of blades can be enhanced. Additionally, the shell, the plurality of respective blades and the plurality of respective reinforcing portions are integrated. In other words, the shell, the plurality of respective blades and the plurality of respective reinforcing portions are included as constituent elements in a single member. Therefore, the member composed of the shell, the plurality of respective blades and the plurality of respective reinforcing portions can be enhanced in stiffness.

Preferably, an outer surface of each of the plurality of reinforcing portions curves to be recessed toward the root as seen in a cross section perpendicular to an extending direction of each of the plurality of reinforcing portions. Therefore, the flow of hydraulic oil can be made smooth in the fluid-type rotary bladed wheel.

Preferably, the fluid-type rotary bladed wheel further includes a core having an annular shape and a plurality of ribs. The core extends in the circumferential direction and is fixed to an axial end surface of each of the plurality of blades. Each of the plurality of ribs extends in the circumferential direction, and is provided on a root between the core and each of the plurality of blades. Each of the plurality of ribs joins the core and each of the plurality of blades. According to this configuration, each of the plurality of ribs is provided on the root between the core and each of the plurality of blades. Hence, joint strength between the core and each of the plurality of blades can be enhanced.

Preferably, the shell, the plurality of respective blades, the core, the plurality of respective reinforcing portions and the plurality of respective ribs are integrated. Thus, the respective members can be provided as constituent elements in a single member. According to this configuration, the member composed of the shell, the plurality of respective blades, the core, the plurality of respective reinforcing portions and the plurality of respective ribs can be enhanced in stiffness.

Preferably, the fluid-type rotary bladed wheel further includes a driven plate integrated with the shell.

Preferably, the shell, the plurality of respective blades and the plurality of respective reinforcing portions are made of at least one selected from the group of aluminum, magnesium and resin.

A fluid-type rotary bladed wheel according to a second aspect of the present disclosure is used for a torque converter. The present fluid-type rotary bladed wheel includes a shell, a plurality of blades, a core having an annular shape, and a plurality of ribs. Each of the plurality of blades is fixed to an inner surface of the shell. Each of the plurality of blades extends in a radial direction and an axial direction. The plurality of respective blades are disposed at intervals in a circumferential direction. The core extends in the circumferential direction and is fixed to an axial end surface of each of the plurality of blades. Each of the plurality of ribs extends in the circumferential direction. Each of the plurality of ribs is provided on a root between the core and each of the plurality of blades, and joins the core and each of the plurality of blades. The plurality of respective blades, the core, and the plurality of respective ribs are integrated.

Incidentally, it is preferable to enhance joint strength between the core and each of the plurality of blades, too. To deal with this, in the fluid-type rotary bladed wheel according to the second aspect of the present disclosure, each of the plurality of ribs extends along the root between the core and each of the plurality of blades. Hence, joint strength between the core and each of the plurality of blades can be enhanced. Additionally, the core, the plurality of respective blades and the plurality of respective ribs are integrated. In other words, the core, the plurality of respective blades and the plurality of respective ribs are included as constituent elements in a single member. Therefore, the member composed of the core, the plurality of respective blades and the plurality of respective ribs can be enhanced in stiffness.

According to the present disclosure, joint strength between each of blades and a shell can be enhanced.

### BRIEF DESCRIPTION OF THE DRAWINGS

FIG. 1 is a cross-sectional side view of a torque converter.

FIG. 2 is a front view of a turbine.

FIG. 3 is a cross-sectional view of FIG. 2 taken along line III-III.

FIG. 4 is a cross-sectional view of FIG. 2 taken along line IV-IV.

FIG. 5 is a cross-sectional perspective view of reinforcing portions.

FIG. 6 is a cross-sectional perspective view of ribs.

### DETAILED DESCRIPTION OF EMBODIMENTS

A turbine, which is an exemplary embodiment of a fluid-type rotary bladed wheel according to the present disclosure, will be hereinafter explained with reference to drawings. It should be noted that in the following explanation, the term “axial direction” means an extending direction of a rotational axis O of the fluid-type rotary bladed wheel. Additionally, the term “radial direction” means a radial direction of an imaginary circle about the rotational axis 0 of the fluid-type rotary bladed wheel. The term “circumferential direction” means a circumferential direction of the imaginary circle about the rotational axis O of the fluid-type rotary bladed wheel.

### Torque Converter

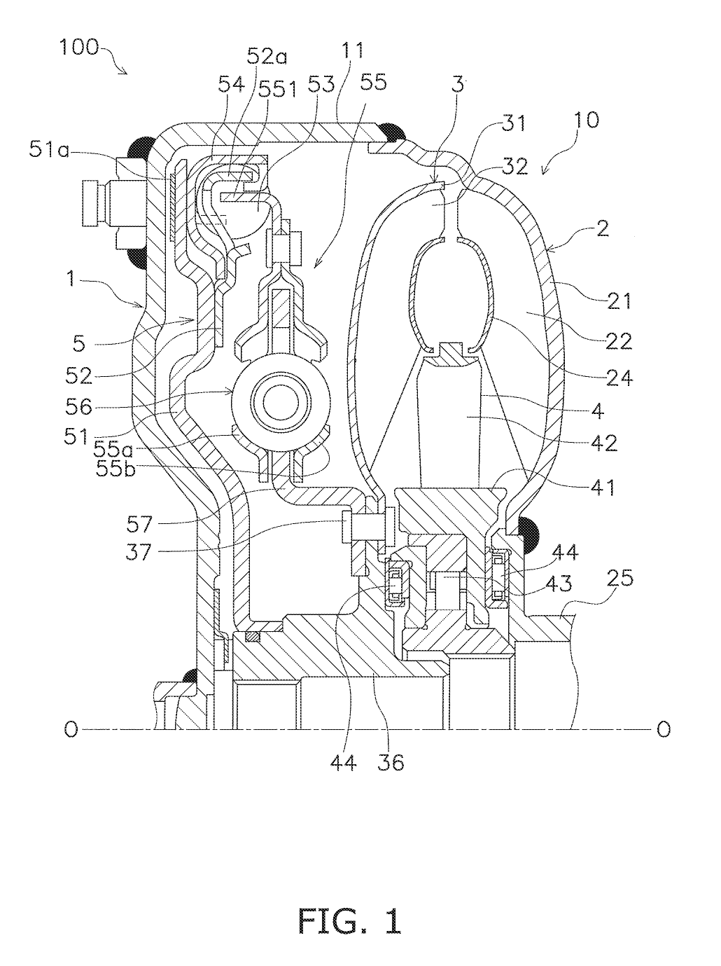

As shown in FIG. 1, a torque converter 100 includes a front cover 1, a torque converter body 10 composed of three types of bladed wheels (an impeller 2, a turbine 3 and a stator 4), and a lock-up device 5.

### Front Cover

The front cover 1 is a disc-shaped member and includes an outer peripheral tubular portion 11 in the outer peripheral portion thereof. The outer peripheral tubular portion 11 protrudes toward a transmission.

### Impeller

The impeller 2 includes an impeller shell 21 (an exemplary shell), a plurality of impeller blades 22 (exemplary blades), reinforcing portions (not shown in the drawings), an impeller core 24 (an exemplary core) and ribs (not shown in the drawings). Additionally, the impeller 2 includes an impeller hub 25. The impeller shell 21 is fixed to the outer peripheral tubular portion 11 of the front cover 1. For example, the impeller shell 21 and the outer peripheral tubular portion 11 are fixed by, for instance, welding. Additionally, the impeller shell 21 is also fixed to the impeller hub 25. The impeller shell 21, the impeller blades 22, the reinforcing portions, the impeller core 24 and the ribs are integrated. It should be noted that the configuration of the impeller 2 is basically the same as that of the turbine 3 to be described, and hence, detailed explanation thereof will be omitted.

### Turbine

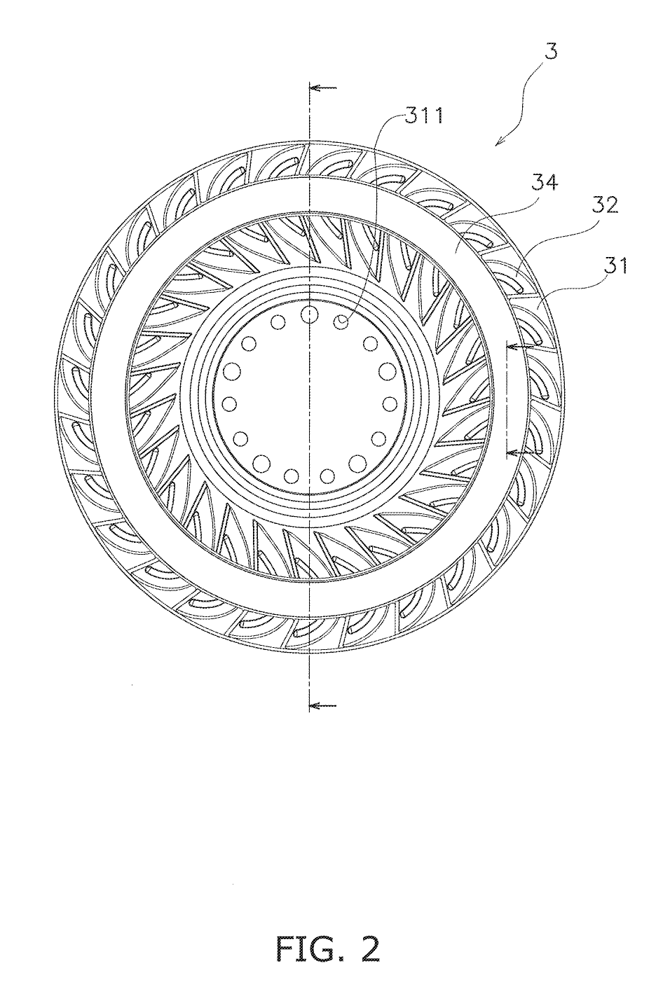

The turbine 3 is disposed in axial opposition to the impeller 2 within a fluid chamber. As shown in FIGS. 2 to 4, the turbine 3 includes a turbine shell 31 (an exemplary shell), a plurality of turbine blades 32 (exemplary blades), at least one reinforcing portion 33, a turbine core 34 (an exemplary core) and at least one rib 35. Additionally, the turbine 3 includes a turbine hub 36 (see FIG. 1).

### Turbine Shell

The turbine shell 31 has a disc shape and includes an opening in the middle thereof. The turbine shell 31 curves to be recessed axially toward the front cover. As described below, the turbine shell 31 is integrated with the turbine blades 32, and hence, does not include through holes into which the turbine blades 32 are inserted. In other words, the turbine shell 31 does not include through holes in a region in which the turbine blades 32 are provided. It should be noted that the turbine shell 31 includes rivet attachment holes 311 in the inner peripheral end thereof so as to be fixed to the turbine hub 36. The turbine shell 31 is fixed to the turbine hub 36 by rivets 37.

### Turbine Blades

The turbine blades 32 are fixed to the inner surface of the turbine shell 31. It should be noted that the inner surface of the turbine shell 31 faces the impeller 2. The respective turbine blades 32 are disposed at intervals from each other in the circumferential direction.

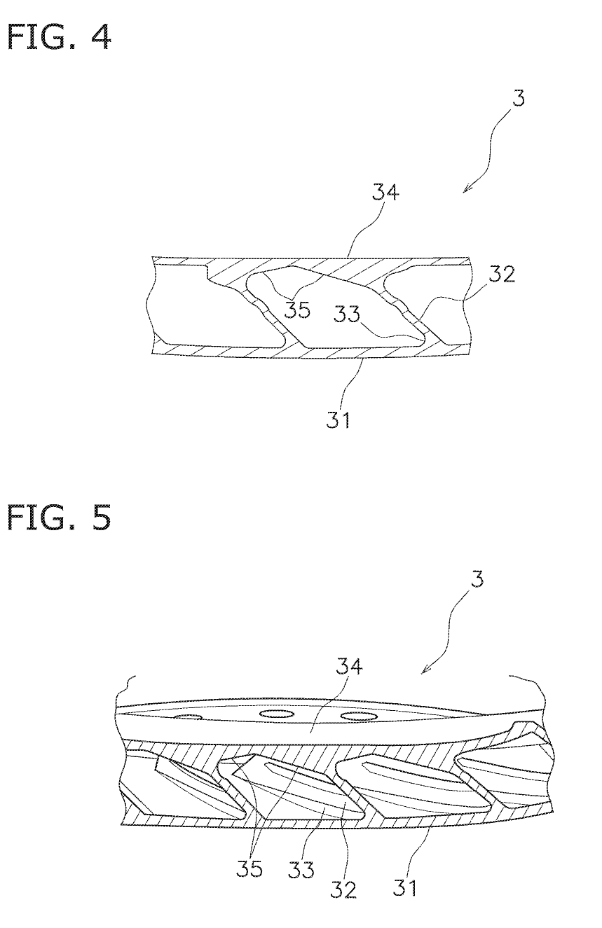

Each of the turbine blades 32 extends in the radial direction and the axial direction. It should be noted that each of the turbine blades 32 curves and extends in the radial direction. Additionally, each of the turbine blades 32 extends in the axial direction, while tilting in the circumferential direction. Therefore, as shown in FIG. 4, an acute angle is formed on one of the two circumferential sides of a root between the turbine shell 31 and each of the turbine blades 32, whereas an obtuse angle is formed on the other of the two circumferential sides of the root. It should be noted that the root between the turbine shell 31 and each of the turbine blades 32 extends in the radial direction. Additionally, the root curves to bulge in the circumferential direction.

### Reinforcing Portions

As shown in FIGS. 4 and 5, the at least one reinforcing portion 33 are portions, each of which is provided for enhancing joint strength between the turbine shell 31 and each of the turbine blades 32. Each of the reinforcing portions 33 joins the turbine shell 31 and each of the turbine blades 32. Each of the reinforcing portions 33 extends along the root between the turbine shell 31 and each of the turbine blades 32. Specifically, each of the reinforcing portions 33 extends along one of the two sides of the root between the turbine shell 31 and each of the turbine blades 32, i.e., the side on which the acute angle is formed between the turbine shell 31 and each of the turbine blades 32. Each of the reinforcing portions 33 reduces in thickness toward both radial ends thereof. In other words, each of the reinforcing portions 33 is greater in thickness at the middle thereof than at both ends thereof. It should be noted that the term “thickness” of each of the reinforcing portions 33 means the dimension of each of the reinforcing portions 33 in the axial direction.

The outer surface of each of the reinforcing portions 33 curves to be recessed toward the root as seen in a cross section perpendicular to the extending direction of each of the reinforcing portions 33. In other words, the outer surface of each of the reinforcing portions 33 has a circular-arc shape as seen in the cross section perpendicular to the extending direction of each of the reinforcing portions 33. The turbine shell 31 and each of the turbine blades 32 are smoothly joined through each of the reinforcing portions 33.

### Turbine Core

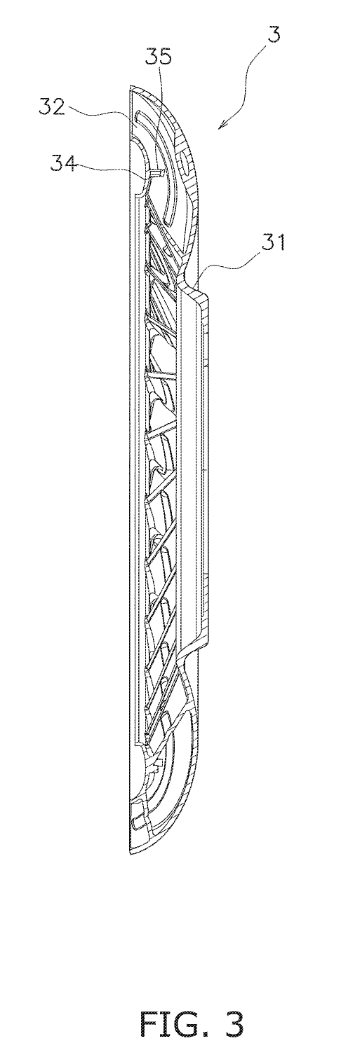

As shown in FIGS. 2 and 3, the turbine core 34 has an annular shape and extends in the circumferential direction. The turbine core 34 is fixed to the axial end surface of each of the turbine blades 32. Detailedly, each of the turbine blades 32 includes a C-shaped recess axially recessed on the axially distal end surface thereof. Additionally, the turbine core 34 is joined thereto along the recess of each of the turbine blades 32.

As described below, the turbine core 34 is integrated with the turbine blades 32, and hence, does not include through holes into which the turbine blades 32 are inserted. In other words, the turbine core 34 does not include through holes in a part thereof to which the turbine blades 32 are joined. It should be noted that the turbine core 34 does not include through holes in the entirety thereof.

### Ribs

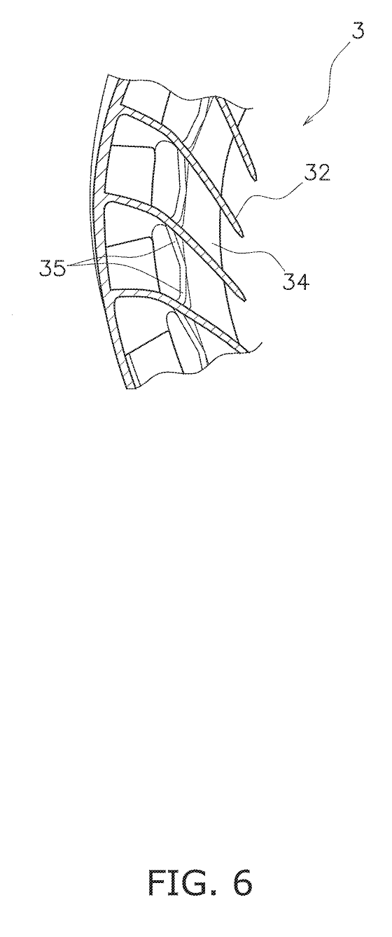

As shown in FIGS. 4 to 6, each of the ribs 35 extends in the circumferential direction. Each of the ribs 35 is provided on a root between the turbine core 34 and each of the turbine blades 32, and joins the turbine core 34 and each of the turbine blades 32. Detailedly, the ribs 35 are provided on both sides of the root between the turbine core 34 and each of the turbine blades 32 in the circumferential direction. In other words, two ribs 35 are provided between adjacent turbine blades 32. The two ribs 35, provided between adjacent turbine blades 32, can continue to each other. Each of the ribs 35 reduces in height with separation from the root in the circumferential direction. It should be noted that the term “height” of each of the ribs 35 means the axial dimension thereof.

The ribs 35 extend along the lower end surface of the turbine core 34. It should be noted that the term “lower end surface” of the turbine core 34 means one surface of the turbine core 34 that is located axially closer to the turbine shell 31 than the other surface thereof. A root between each of the ribs 35 and each of the turbine blades 32 has a circular-arc shape as seen in a cross section taken along the extending direction of each of the ribs 35.

### Method of Manufacturing Turbin

The turbine shell 31, the respective turbine blades 32, the respective reinforcing portions 33, the turbine core 34 and the respective ribs 35 are integrated. In other words, the turbine shell 31, the respective turbine blades 32, the respective reinforcing portions 33, the turbine core 34 and the respective ribs 35 are included as constituent elements in a single member. For example, the turbine shell 31, the respective turbine blades 32, the respective reinforcing portions 33, the turbine core 34 and the respective ribs 35 can be made of aluminum, magnesium, resin or so forth.

The turbine shell 31, the respective turbine blades 32, the respective reinforcing portions 33, the turbine core 34 and the respective ribs 35 can be integrally formed by three-dimensional lamination shaping. When the turbine 3 is formed by three-dimensional lamination shaping, it is preferable to form the turbine 3, for example, from the turbine shell 31 side toward the turbine core 34 in the axial direction.

Detailedly, as a first step, the turbine shell 31 is formed; as a second step, the turbine shell 31, the turbine blades 32 and the reinforcing portions 33 are simultaneously formed; as a third step, the turbine shell 31 and the turbine blades 32 are simultaneously formed; as a fourth step, the turbine shell 31, the turbine blades 32 and the ribs 35 are simultaneously formed; and as a fifth step, the turbine shell 31, the turbine blades 32 and the turbine core 34 are simultaneously formed. The turbine 3 is completely formed by sequentially executing the first to fifth steps. It should be noted that as a sixth step, a step of simultaneously forming the turbine shell 31 and the turbine core 34 can be executed after the fifth step.

### Stator

As shown in FIG. 1, the stator 4 is a mechanism disposed between the inner peripheral part of the impeller 2 and that of the turbine 3 so as to regulate the flow of hydraulic oil returning from the turbine 3 to the impeller 2. The stator 4 is mainly composed of a stator carrier 41 and a plurality of stator blades 42 provided on the outer peripheral surface of the stator carrier 41. The stator carrier 41 is supported by a stationary shaft (not shown in the drawings) through a one-way clutch 43. It should be noted that thrust bearings 44 are provided axially on both sides of the stator carrier 41.

### Lock-Up Device

The lock-up device 5 is disposed in a space between the front cover 1 and the turbine 3. The lock-up device 5 includes a piston 51, a drive plate 52, a plurality of outer peripheral side torsion springs 53, a float member 54, an intermediate member 55, a plurality of inner peripheral side torsion springs 56 and a driven plate 57.

The piston 51 has an annular shape and is supported by the outer peripheral surface of the turbine hub 36 so as to be axially movable and be rotatable relatively thereto. The piston 51 includes a friction member 51a having an annular shape. When the friction member 51a is pressed onto the front cover 1, a torque is transmitted from the front cover 1 to the piston 51.

The drive plate 52 is fixed to the piston 51. The drive plate 52 is provided with a plurality of engaging portions 52a in the outer peripheral part thereof. The engaging portions 52a are engaged with both circumferential ends of the outer peripheral side torsion springs 53. The float member 54 is an annular member having a C-shaped cross section, and supports the outer peripheral side torsion springs 53.

The intermediate member 55 is composed of a first plate 55a and a second plate 55b, and is rotatable relatively to the drive plate 52 and the driven plate 57. The first plate 55a is provided with a plurality of engaging portions 551 that are engaged with the outer peripheral side torsion springs 53. The inner peripheral side torsion springs 56 are disposed between the first plate 55a and the second plate 55b. The intermediate member 55 enables the outer peripheral side torsion springs 53 and the inner peripheral side torsion springs 56 to act in series.

The driven plate 57 is an annular disc-shaped member and is fixed at the inner peripheral part thereof together with the turbine shell 31 to the turbine hub 36 by the rivets 37. The driven plate 57 is disposed between the first plate 55a and the second plate 55b, while being rotatable relatively to both plates 55a and 55b. The driven plate 57 is provided with holes for accommodating the inner peripheral side torsion springs 56 in the outer peripheral part thereof.

The torque transmitted to the piston 51 is transmitted through a path of “the drive plate 52→the outer peripheral side torsion springs 53→the intermediate member 55 the inner peripheral side torsion springs 56→the driven plate 57” and is then outputted to the turbine hub 36.

### MODIFICATIONS

One exemplary embodiment of the present disclosure has been explained above. However, the present disclosure is not limited to this, and a variety of changes can be made without departing from the gist of the present advancement.

### Modification 1

In the aforementioned exemplary embodiment, the driven plate 57 is fixed to the turbine shell 31 by the rivets 37. However, the configuration of the driven plate 57 is not limited to this. For example, the driven plate 57 can be integrated with the turbine shell 31.

### Modification 2

In the aforementioned exemplary embodiment, each of the ribs 35 is made in the shape of a plate extending in the circumferential direction and the axial direction. However, the shape of each of the ribs 35 is not limited to this. For example, the shape of each of the ribs 35 can extend in the radial direction as well. In this case, each of the ribs 35 can be also configured to gradually increase in height from the radially inside and outside thereof toward the middle thereof. When each of the ribs 35 has the shape described above, the flow of hydraulic oil can be made smooth without being hindered by the ribs 35.

### Modification 3

In the aforementioned exemplary embodiment, when formed by three-dimensional lamination shaping, the turbine 3 is gradually formed from the turbine shell 31 side toward the turbine core 34. However, the turbine 3 can be formed in the opposite direction from the turbine core 34 side toward the turbine shell 31.

### REFERENCE SIGNS LIST

2: Impeller

3: Turbine

31: Turbine shell

32: Turbine blade

33: Reinforcing portion

34: Turbine core

35: Rib

57: Driven plate

100: Torque converter

1. A fluid-type rotary bladed wheel to be used for a torque converter, the fluid-type rotary bladed wheel comprising:
a shell;
a plurality of blades each fixed to an inner surface of the shell, each of the plurality of blades extending in a radial direction and an axial direction, the plurality of respective blades disposed at intervals in a circumferential direction; and
a plurality of reinforcing portions each extending in the radial direction along a root between the shell and each of the plurality of blades, each of the plurality of reinforcing portions joining the shell and each of the plurality of blades, wherein
the shell, the plurality of blades and the plurality of reinforcing portions are integrated.

2. The fluid-type rotary bladed wheel according to claim 1, wherein an outer surface of each of the plurality of reinforcing portions curves to be recessed toward a site of the root as seen in a cross section perpendicular to an extending direction of each of the plurality of reinforcing portions.

3. The fluid-type rotary bladed wheel according to claim 1, further comprising:
a core having an annular shape, the core extending in the circumferential direction, the core fixed to an axial end surface of each of the plurality of blades; and
a plurality of ribs each extending in the circumferential direction, each of the plurality of ribs provided on a root between the core and each of the plurality of blades, each of the plurality of ribs joining the core and each of the plurality of blades.

4. The fluid-type rotary bladed wheel according to claim 3, wherein the shell, the plurality of respective blades, the core, the plurality of respective reinforcing portions and the plurality of respective ribs are integrated.

5. The fluid-type rotary bladed wheel according to claim 1, further comprising:
a driven plate integrated with the shell.

6. The fluid-type rotary bladed wheel according to claim 1, wherein the shell, the plurality of respective blades and the plurality of respective reinforcing portions are made of at least one selected from the group of aluminum, magnesium and resin.

7. A fluid-type rotary bladed wheel to be used for a torque converter, the fluid-type rotary bladed wheel comprising:
a shell;
a plurality of blades each fixed to an inner surface of the shell, each of the plurality of blades extending in a radial direction and an axial direction, the plurality of respective blades disposed at intervals in a circumferential direction;
a core having an annular shape, the core extending in the circumferential direction, the core fixed to an axial end surface of each of the plurality of blades; and
a plurality of ribs each extending in the circumferential direction, each of the plurality of ribs provided on a root between the core and each of the plurality of blades, each of the plurality of ribs joining the core and each of the plurality of blades, wherein
the plurality of respective blades, the core, and the plurality of respective ribs are integrated.
